(19) United States
(12) Patent Application Publication
(10) Pub. No.: US 2019/0056062 A1
(43) Pub. Date: Feb. 21, 2019

(54) CRYOGENIC LIQUID TANK

(71) Applicant: IHI Corporation, Tokyo (JP)

(72) Inventor: Chikahide TSUJI, Tokyo (JP)

(73) Assignee: IHI Corporation, Tokyo (JP)

(21) Appl. No.: 16/078,834

(22) PCT Filed: Feb. 22, 2017
(86) PCT No.: PCT/JP2017/006535

§ 371 Date: Aug. 22, 2018

(30) Foreign Application Priority Data
Feb. 24, 2016 (JP) 2016-033469

(51) Int. Cl. F17C 1/02; E04H 7/06; F17C 13/08; E04H 7/18; F17C 13/00

(52) U.S. Cl. CPC F17C 1/02; F17C 2270/05; F17C 13/081; E04H 7/18; F17C 13/001; F17C 2201/032; F17C 2203/011; F17C 2203/0333; F17C 2203/0621; F17C 2203/0639; F17C 2203/0678; F17C 2205/0126; F17C 2205/0184; F17C 2260/011; E04H 7/06

(57) ABSTRACT

A cryogenic liquid tank (1) includes a reservoir (5) that includes a bottom portion (5a, 5a1, or 5a2) and a side wall (5b), a support portion (4) that supports the reservoir (5), and an intermediate member (10) that is provided between the reservoir (5) and the support portion (4). The support portion (4) includes an outer support portion (4b) which supports the side wall (5b), and an inner support portion (4a) which is disposed to be adjacent to an inner side of the outer support portion (4b), includes a heat insulating layer formed of an elastic material, and supports the bottom portion (5a, 5a1, or 5a2) of the reservoir (5). A cover portion (9a, 9a1, or 15) covering a boundary between the outer support portion (4b) and the inner support portion (4a) is provided between the support portion (4) and the intermediate member (10).

### TECHNICAL FIELD

The present disclosure relates to a cryogenic liquid tank.

Priority is claimed on Japanese Patent Application No. 2016-33469, filed on Feb. 24, 2016, the content of which is incorporated herein by reference.

### BACKGROUND ART

A tank for storing cryogenic liquid (cryogenic liquid tank), such as a liquefied natural gas (LNG) tank, includes a reservoir in which cryogenic liquid is accumulated and a support portion (bottom portion cold reserving layer) which supports the reservoir.

In the related art, pearlite concrete has been used for an outer circumferential portion of a support portion, a heat insulating material has been used for a central portion of the support portion, and an annular plate has been disposed between the outer circumferential portion and a reservoir (for example, refer to PTL 1). In addition, as a heat insulating material, cellular glass known as a non-elastic material, or rigid polyurethane foam known as an elastic material has been used (for example, refer to PTL 2).

### CITATION LIST

### Patent Literature

[PTL 1] Japanese Unexamined Patent Application, First Publication No. H10-37513

[PTL 2] Japanese Unexamined Utility Model Application Publication No. S60-67499

### SUMMARY OF INVENTION

### Technical Problem

In an LNG tank in which rigid polyurethane foam is used for a central portion of a support portion, if a liquid pressure is applied to a reservoir while the LNG tank is in operation, there is a possibility that a step part will be generated between pearlite concrete and the rigid polyurethane foam due to the difference between their material characteristics. Otherwise, there is a possibility that rigid polyurethane foam will be gradually precipitated (creep deformation) with time and will generate a step part due to the LNG tank which has been used over a long period of time.

If a step part is generated in this manner, there is a possibility that a concrete member positioned above the step part will be rapidly and locally deformed, a bottom portion of the reservoir positioned on the concrete member will be deformed, and bending stress will be rapidly and locally applied to the bottom portion, so that a significant load will be added to the bottom portion.

The present disclosure has been made in consideration of the foregoing circumstances, and an object thereof is to prevent a significant load from being applied to a bottom portion of a reservoir in a cryogenic liquid tank while being in use.

### Solution to Problem

According to a first aspect of the present disclosure, there is provided a cryogenic liquid tank including a reservoir that includes a bottom portion and a side wall, a support portion that supports the reservoir, and an intermediate member that is provided between the reservoir and the support portion. The support portion includes an outer support portion which supports the side wall, and an inner support portion which is disposed to be adjacent to an inner side of the outer support portion, includes a heat insulating layer formed of an elastic material, and supports the bottom portion of the reservoir. A cover portion covering a boundary between the outer support portion and the inner support portion is provided between the support portion and the intermediate member.

### Advantageous Effects of Invention

According to the present disclosure, the cover portion covering the boundary between the outer support portion and the inner support portion is provided between the support portion and the intermediate member. Therefore, even in a case where a step part is generated between the outer support portion and the inner support portion, the cover portion restrains the intermediate member from being rapidly and locally deformed, so that the intermediate member is gently deformed in the boundary between the outer support portion and the inner support portion. Consequently, the bottom portion of the reservoir positioned on the intermediate member is prevented from being locally deformed. Accordingly, local bending stress caused by a generated step part can be prevented from being applied to the bottom portion of the reservoir. Therefore, according to the present disclosure, in the cryogenic liquid tank including the support portion that supports the reservoir, it is possible to prevent a significant load from being applied to the bottom portion of the reservoir while being in use.

### BRIEF DESCRIPTION OF DRAWINGS

FIG. 1 is a longitudinal sectional view schematically showing an outline configuration of a cryogenic liquid tank according to an embodiment of the present disclosure.

FIG. 2 is a sectional view showing an outer circumferential portion of a bottom portion cold reserving layer included in the cryogenic liquid tank according to the embodiment of the present disclosure and is an enlarged sectional view showing a part indicated with a reference sign P in FIG. 1.

FIG. 3 is a sectional view showing the outer circumferential portion of the bottom portion cold reserving layer included in a cryogenic liquid tank according to Deformation Example 1 of the embodiment of the present disclosure, and is an enlarged sectional view showing a part indicated with the reference sign P in FIG. 1.

FIG. 4 is a sectional view showing the outer circumferential portion of the bottom portion cold reserving layer included in a cryogenic liquid tank according to Deformation Example 2 of the embodiment of the present disclosure, and is an enlarged sectional view showing a part indicated with the reference sign P in FIG. 1.

FIG. 5 is another sectional view showing the outer circumferential portion of the bottom portion cold reserving layer included in the cryogenic liquid tank according to Deformation Example 2 of the embodiment of the present disclosure, and is an enlarged sectional view showing a part indicated with the reference sign P in FIG. 1.

### DESCRIPTION OF EMBODIMENT

Hereinafter, with reference to the drawings, an embodiment of a cryogenic liquid tank according to the present disclosure will be described. In the drawings described below, in order to depict each of the members in a recognizable size, the scale of each of the members is suitably changed. In addition, the present embodiment will be described with an LNG tank as an example of a cryogenic liquid tank.

In the following description, a “radial direction” denotes a radial direction in a plane shape of the cryogenic liquid tank. A “radially inward direction” denotes a direction toward a middle part from the circumference in a plane shape of the cryogenic liquid tank, and a “radially outward direction” denotes a direction toward the circumference from the middle part in a plane shape of the cryogenic liquid tank.

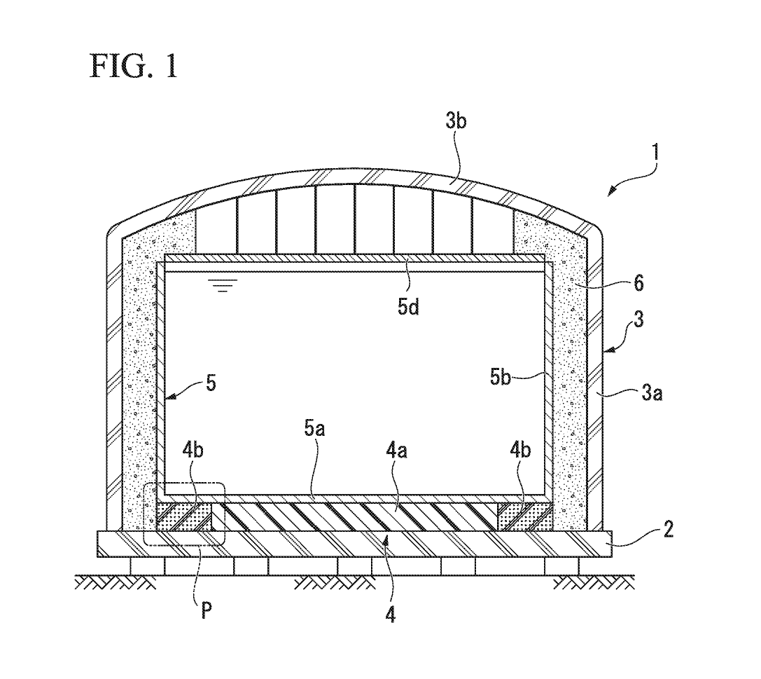

FIG. 1 is a longitudinal sectional view showing an outline configuration of a ground-type cryogenic liquid tank 1 according to the embodiment of the present disclosure. As shown in FIG. 1, the cryogenic liquid tank 1 according to the present embodiment is a pre-stressed concrete (PC) tank including a foundation floor slab 2, an outer tank 3, a bottom portion cold reserving layer 4 (support portion), an inner tank 5 (reservoir), and a side portion cold reserving layer 6. In FIG. 1, a blanket 7, a pearlite 8, a thermal corner protection 9, and a lean concrete 10 are omitted and will be described below.

The foundation floor slab 2 is a foundation for supporting the outer tank 3, the inner tank 5, and the like from below. The foundation floor slab 2 is formed in a substantial disk shape having a diameter greater than that of the outer tank 3 when seen from above in a vertical direction. In this foundation floor slab 2, a heater (not shown) is installed to prevent cold energy of stored LNG from being transferred into the ground. The outer tank 3 is a container formed of pre-stressed concrete. The outer tank 3 stands on the foundation floor slab 2 such that the inner tank 5 is covered. This outer tank 3 includes a cylindrically shaped outer tank side wall 3a, and an outer tank ceiling portion 3b connected to an upper edge portion of the outer tank side wall 3a.

The inner tank 5 is a cylindrical metal container installed on the bottom portion cold reserving layer 4 and includes an opening portion and a bottom portion. LNG is stored inside the inner tank 5. Specifically, the inner tank 5 includes an inner tank bottom portion 5a (bottom portion), an inner tank side wall 5b (side wall) standing at an edge portion of the inner tank bottom portion 5a, and a ceiling 5d covering the opening portion of the inner tank 5. The ceiling 5d is suspended from the outer tank ceiling portion 3b to be supported.

The side portion cold reserving layer 6 is disposed between the outer tank side wall 3a and the inner tank side wall 5b and is formed by being filled with granular pearlite. In addition, as shown in FIG. 1, the side portion cold reserving layer 6 is formed to reach an upper portion of the inner tank 5. The side portion cold reserving layer 6 fill the sides of retaining walls (not illustrated) formed at an upper portion of the ceiling 5d and is disposed in an upper portion of an outer circumferential portion of the ceiling 5d.

The bottom portion cold reserving layer 4 is mounted on the upper surface of the foundation floor slab 2 and supports the inner tank 5 from below. This bottom portion cold reserving layer 4 is formed in a substantial disk shape having a diameter smaller than that of the foundation floor slab 2 and is disposed coaxially with the foundation floor slab 2 when seen from above in the vertical direction. This bottom portion cold reserving layer 4 includes an outer support portion 4b and an inner support portion 4a. The inner support portion 4a is surrounded by the outer support portion 4b when seen from above in the vertical direction.

The outer support portion 4b supports the edge portion of the inner tank 5 including the inner tank side wall 5b of the inner tank 5. The outer support portion 4b is formed of pearlite concrete.

The inner support portion 4a supports the inner tank bottom portion 5a of the inner tank 5 and is disposed to be adjacent to an inner side of the outer support portion 4b. The inner support portion 4a includes a heat insulating layer formed of an elastic material.

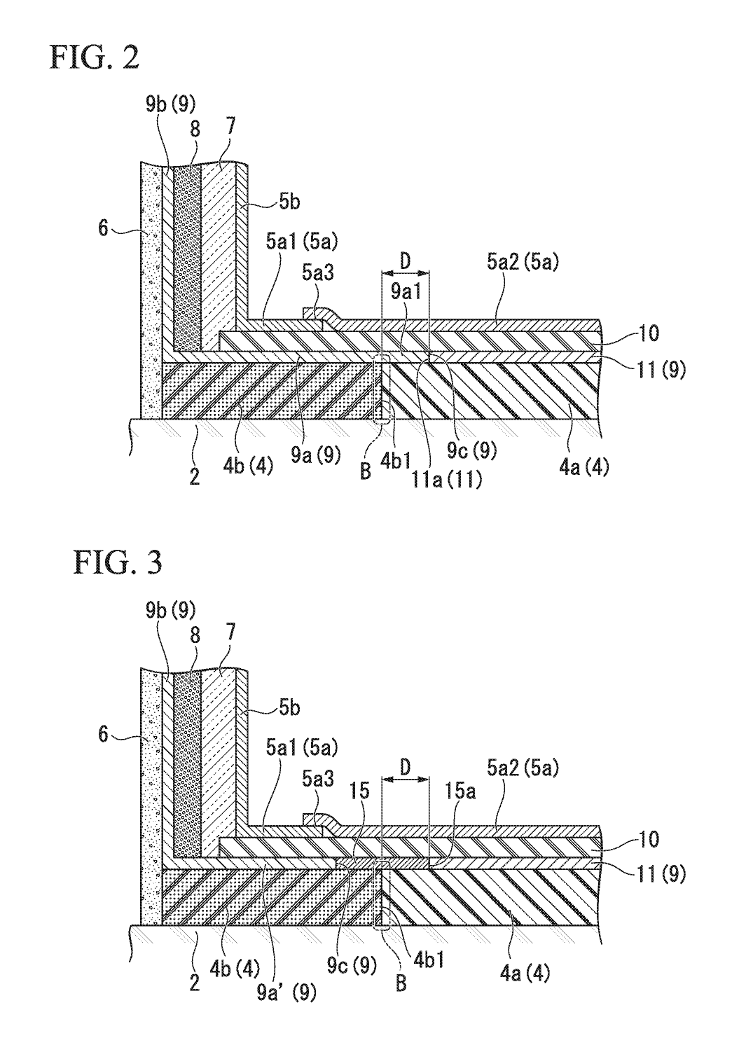

FIG. 2 is an enlarged view in which a part indicated with a reference sign P in FIG. 1 is enlarged. In FIG. 2, in order to emphasize the difference between heights of the members, the height of each member is particularly changed and is shown compared to the actual dimensions.

As shown in FIG. 2, the blanket 7 covering the inner tank 5 is disposed on an outer side (in the radially outward direction) of the inner tank side wall 5b. The blanket 7 has a cold reserving function and absorbs thermal deformation of the inner tank 5. The pearlite 8 covering the blanket 7 is disposed on an outer side (in the radially outward direction) of the blanket 7. For example, the pearlite 8 is a foam body such as a porous material. A thermal corner wall plate 9b (thermal corner protection plate) constituting the thermal corner protection 9 is disposed on an outer side (in the radially outward direction) of the pearlite 8. The side portion cold reserving layer 6 described above is disposed on an outer side (in the radially outward direction) of the thermal corner wall plate 9b.

The thermal corner protection 9 includes the thermal corner wall plate 9b extending in the vertical direction and an annular plate 9a (thermal corner protection plate) extending in the horizontal direction and having a thickness of 8 mm. The thermal corner protection 9 is formed in an L-shape in a sectional view. The annular plate 9a is connected to a lower end of the thermal corner wall plate 9b formed between the pearlite 8 and the side portion cold reserving layer 6.

The bottom portion cold reserving layer 4 is constituted of the outer support portion 4b (outer circumferential portion) disposed below the inner tank side wall 5b of the inner tank 5, and the inner support portion 4a (central portion) disposed on the inner side of the outer support portion 4b.

The outer support portion 4b is provided below the annular plate 9a and supports the annular plate 9a. The outer support portion 4b is provided annularly along the inner tank side wall 5b of the inner tank 5 (in the circumferential direction of the cryogenic liquid tank 1).

The inner support portion 4a is installed on the foundation floor slab 2 and includes a heat insulating layer. The heat insulating layer included in the inner support portion 4a is formed of rigid polyurethane foam and prevents heat from entering the inner tank 5 from the ground surface.

A thermal corner bottom plate 11 (thermal corner protection plate) constituting the thermal corner protection 9 is provided on the inner support portion 4a. FIG. 2 shows a structure in which only one thermal corner bottom plate 11 is provided on the inner support portion 4a on the inner side of the annular plate 9a having an annular shape. However, a plurality of thermal corner bottom plates 11 are disposed on the upper surface of the inner support portion 4a. The thermal corner bottom plates 11 are provided to be adjacent to the annular plate 9a. The positions of outer end surfaces 11a of the thermal corner bottom plates 11 and the position of an inner end surface 9c (an inner end surface of an extending portion 9a1 (which will be described below)) of the annular plate 9a are the same as each other.

The lean concrete 10 is disposed on the upper surface of the annular plate 9a and the upper surfaces of the thermal corner bottom plates 11 to cover the inner end surface 9c and the outer end surfaces 11a. The lean concrete 10 is provided between the inner tank 5 and the bottom portion cold reserving layer 4 (the outer support portion 4b and the inner support portion 4a) and is an example of an “intermediate member”. The lean concrete 10 overlaps a boundary B between the outer support portion 4b and the inner support portion 4a when seen from above in the vertical direction.

An outer bottom plate 5a1 (bottom portion) and an inner bottom plate 5a2 (bottom portion) which form the inner tank bottom portion 5a are disposed on the upper surface of the lean concrete 10. The outer bottom plate 5a1 is connected to the inner tank side wall 5b and forms an L-shaped member in a sectional view. The outer bottom plate 5a1 and the inner bottom plate 5a2 are joined to each other through welding or the like at a joint portion 5a3 and are supported by a support surface (upper surface) of the lean concrete 10.

FIG. 2 shows a structure in which only one inner bottom plate 5a2 is provided on the lean concrete 10 on the inner side of the annular outer bottom plate 5a1. However, a plurality of inner bottom plates 5a2 are disposed on the upper surface of the lean concrete 10, and adjacent inner bottom plates 5a2 are joined to each other through welding or the like.

For example, the material of the outer bottom plate 5a1 and the inner bottom plates 5a2 is nickel steel.

A specific structure of the annular plate 9a will be described.

The annular plate 9a includes the extending portion 9a1. The extending portion 9a1 is provided on the outer support portion 4b (the upper surface of the outer support portion 4b) and on the inner support portion 4a (the upper surface of the inner support portion 4a) and extends from the outer support portion 4b toward the inner support portion 4a.

The annular plate 9a including the extending portion 9a1 is an example of a “cover portion”.

The extending portion 9a1 is integrally formed with the annular plate 9a. The extending portion 9a1 is provided on the inner support portion 4a and covers the boundary B between the outer support portion 4b and the inner support portion 4a when seen from above in the vertical direction.

A distance D from an end portion 4b1 of the outer support portion 4b to the inner end surface 9c of the extending portion 9a1 is adequately set in accordance with the construction cost of the cryogenic liquid tank 1. For example, the upper limit for the distance D is 500 mm. If the distance D exceeds 500 mm, the construction cost will increase, which is not preferable.

An extending pattern (plane shape, plane pattern) of the extending portion 9a1 seen from above in the vertical direction covers an outer end (a position coincides with the boundary B) of the inner support portion 4a and has a substantially circular shape.

In the plane pattern of the extending portion 9a1, partially protruding portions protruding in the radially inward direction may be provided at an equal angular pitch. In other words, the distance D is not necessarily a constant value, and the distance D of the extending portion in which the partially protruding portions are provided may be greater than the distance D of the extending portion in which the partially protruding portions are not provided.

In the cryogenic liquid tank 1 according to the present embodiment, since LNG is stored inside the inner tank 5, liquid pressure is applied to the inner tank 5 while the cryogenic liquid tank 1 is in operation. Particularly, if liquid pressure is added to the inner tank bottom portion 5a of the inner tank 5, a load corresponding to the liquid pressure is applied to the lean concrete 10 positioned below the inner tank bottom portion 5a. Moreover, a load added to the lean concrete 10 is applied to the annular plate 9a and the thermal corner bottom plates 11 positioned below the lean concrete 10. Moreover, a load applied to the annular plate 9a and the thermal corner bottom plates 11 is added to the bottom portion cold reserving layer 4. Since the heat insulating layer included in the inner support portion 4a constituting the bottom portion cold reserving layer 4 is formed of rigid polyurethane foam which is an elastic material, the inner support portion 4a is precipitated due to a load corresponding to the liquid pressure of LNG. Moreover, rigid polyurethane foam is gradually precipitated (creep deformation) with time due to the cryogenic liquid tank 1 which has been used over a long period of time. Specifically, there are cases where the inner support portion 4a is relatively settled down approximately 10 mm to 20 mm with respect to the outer support portion 4b and a step part is generated in the boundary B.

Particularly, as in the related art, in a case of a structure in which lean concrete is in direct contact with a step part, the lean concrete is locally deformed due to the step part. Particularly, at a site in which lean concrete and a step part are in contact with each other, the lean concrete is rapidly bent and is deformed. In response to deformation of the lean concrete, an inner tank bottom portion positioned on the lean concrete is locally deformed.

In contrast, in the cryogenic liquid tank 1 according to the present embodiment, the annular plate 9a (cover portion) covers the boundary B between the outer support portion 4b and the inner support portion 4a. Therefore, even if the step part described above is generated in the boundary B, the annular plate 9a including the extending portion 9a1 covers the step part, the lean concrete 10 is restrained from being rapidly and locally deformed, and the lean concrete 10 is gently deformed. Since local deformation of the lean concrete 10 is restrained, the inner tank bottom portion 5a positioned on the lean concrete 10 is prevented from being locally deformed. Accordingly, local bending stress caused by the generated step part can be prevented from being applied to the inner tank bottom portion 5a. Therefore, according to the present embodiment, in the cryogenic liquid tank 1 including the bottom portion cold reserving layer 4 supporting the inner tank 5, it is possible to prevent a significant load from being applied to the inner tank bottom portion 5a of the inner tank 5 while being in use.

In addition, the annular plate 9a covers the boundary B between the outer support portion 4b and the inner support portion 4a. Therefore, even if a step part is generated in the boundary B between the outer support portion 4b and the inner support portion 4a, the annular plate 9a including the extending portion 9a1 covers the step part, so that the thermal corner bottom plates 11 and the step part can be prevented from coming into contact with each other. Accordingly, bending stress caused by such contact can be prevented from being applied to the thermal corner bottom plates 11.

In addition, in the cryogenic liquid tank 1 according to the present embodiment, since the annular plate 9a covers the boundary B, there is no need to dispose a separate member different from the annular plate 9a in the boundary B, and the number of components constituting the cryogenic liquid tank 1 can be reduced.

FIG. 3 is a sectional view showing the outer circumferential portion of the bottom portion cold reserving layer included in a cryogenic liquid tank according to Deformation Example 1 of the embodiment of the present disclosure, and is an enlarged sectional view showing a part indicated with the reference sign P in FIG. 1.

In FIG. 3, the same reference signs are applied to the same members as those in the embodiment described above and description thereof is omitted or simplified.

The present Deformation Example 1 differs from the embodiment described above in that the cryogenic liquid tank 1 includes a cover plate which is a member separated from an annular plate 9a′.

As shown in FIG. 3, a cover plate 15 is provided to be adjacent to the inner side of the annular plate 9a′ disposed on the outer support portion 4b and is a member separated from the annular plate 9a′.

The length of the annular plate 9a′ in the radial direction of the cryogenic liquid tank 1 shown in FIG. 3 is shorter than the length of the annular plate 9a shown in FIG. 1, and the cover plate 15 is disposed to abut on the inner end surface 9c of the annular plate 9a′. The cover plate 15 may be connected to the annular plate 9a′ through welding or the like. The cover plate 15 is an example of a “cover portion”.

Specifically, the cover plate 15 is provided on the outer support portion 4b and on the inner support portion 4a, extends in a direction from the outer support portion 4b toward the inner support portion 4a, and covers the boundary B between the outer support portion 4b and the inner support portion 4a when seen from above in the vertical direction.

The lean concrete 10 is disposed on the upper surface of the annular plate 9a′, the upper surface of the cover plate 15, and the upper surface of the thermal corner bottom plates 11 to cover the inner end surface 9c and an inner end surface 15a.

The distance D from the end portion 4b1 of the outer support portion 4b to the inner end surface 15a of the cover plate 15 is similar to that of the embodiment described above. For example, the plane pattern of the cover plate 15 may be a pattern similar to that of the extending portion 9a1 described above.

In the present Deformation Example 1, the cover plate 15 covers the boundary B between the outer support portion 4b and the inner support portion 4a. Therefore, even if the step part described above is generated in the boundary B, since the cover plate 15 covers the step part, the lean concrete 10 is restrained from being rapidly and locally deformed, so that the lean concrete 10 is gently deformed. Since local deformation of the lean concrete 10 is restrained, the inner tank bottom portion 5a positioned on the lean concrete 10 is prevented from being locally deformed. Accordingly, local bending stress caused by the generated step part can be prevented from being applied to the inner tank bottom portion 5a. Therefore, according to the present deformation example, in the cryogenic liquid tank 1 including the bottom portion cold reserving layer 4 supporting the inner tank 5, it is possible to prevent a significant load from being applied to the inner tank bottom portion 5a of the inner tank 5 while being in use.

In addition, the cover plate 15 covers the boundary B between the outer support portion 4b and the inner support portion 4a. Therefore, even if a step part is generated in the boundary B between the outer support portion 4b and the inner support portion 4a, the cover plate 15 covers the step part, so that the thermal corner bottom plates 11 and the step part can be prevented from coming into contact with each other. Accordingly, bending stress caused by such contact can be prevented from being applied to the thermal corner bottom plates 11.

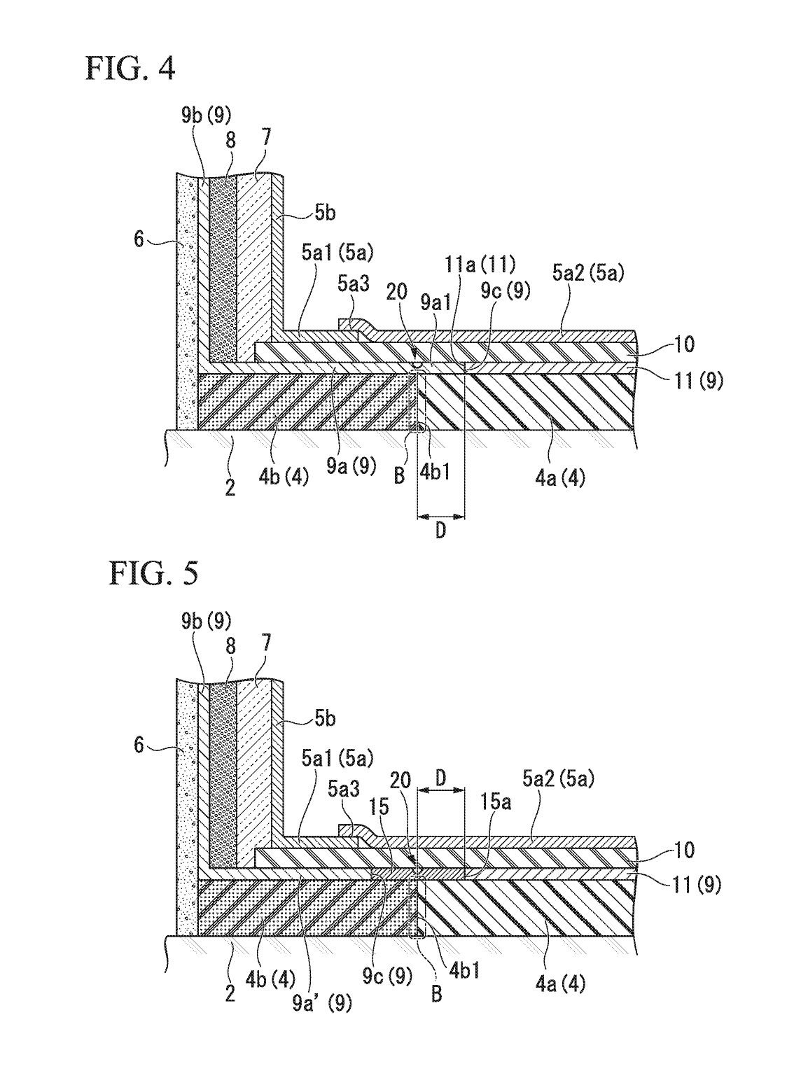

FIG. 4 is a sectional view showing the outer circumferential portion of the bottom portion cold reserving layer included in a cryogenic liquid tank according to Deformation Example 2 of the embodiment of the present disclosure, and is an enlarged sectional view showing a part indicated with the reference sign P in FIG. 1.

In FIG. 4, the same reference signs are applied to the same members as those in the embodiment described above and a description thereof is omitted or simplified.

The present Deformation Example 2 differs from the embodiment described above in that the annular plate 9a includes a recess portion 20.

Specifically, as shown in FIG. 4, the recess portion 20 is provided at a position overlapping the boundary B between the outer support portion 4b and the inner support portion 4a. The extending portion 9a1 extends to protrude from the end portion 4b1 of the outer support portion 4b toward the inner end surface 9c of the annular plate 9a from the recess portion 20. In other words, the recess portion 20 is provided in a root portion of the extending portion 9a1.

In the present Deformation Example 2, the inner support portion 4a is precipitated due to liquid pressure added to the inner tank bottom portion 5a of the inner tank 5, or rigid polyurethane foam constituting the inner support portion 4a is gradually precipitated with time due to the cryogenic liquid tank 1 which has been used over a long period of time. Therefore, the inner tank bottom portion 5a is pressed down, and a step part is generated in the boundary B between the outer support portion 4b and the inner support portion 4a. As a result of the generated step part, a load is also applied to the extending portion 9a1. Since the annular plate 9a includes the recess portion 20 provided at a position corresponding to the boundary B, a load is applied to the annular plate 9a, so that the annular plate 9a is likely to be deformed in the recess portion 20. Therefore, if a load is added to the annular plate 9a such that the inner tank bottom portion 5a is pressed down, the annular plate 9a is deformed in the recess portion 20 such that a portion of the annular plate 9a from the recess portion 20 to the inner end surface 9c is directed obliquely downward (that is, directed toward the inner support portion 4a).

Therefore, according to the present Deformation Example 2, it is possible to not only achieve effects similar to those of the embodiment described above but also cause the annular plate 9a to be deformed in accordance with a load applied to the inner tank bottom portion 5a, so that the lean concrete 10 can be restrained from being locally deformed. It is possible to relax stress generated in the joint portion 5a3 provided between the outer bottom plate 5a1 and the inner bottom plates 5a2, or stress generated in the inner tank bottom portion 5a in a dispersive manner.

The recess portion 20 described in the present Deformation Example 2 may also be applied to Deformation Example 1 described above. Specifically, as illustrated in FIG. 5, in a configuration in which the cover plate 15 is provided at a position overlapping the boundary B, the recess portion 20 may be formed in the cover plate 15 at a position overlapping the boundary B. Even in this case as well, it is possible to achieve the effects described above.

Hereinabove, the embodiment and the deformation examples of the present disclosure have been described with reference to the drawings. However, the present disclosure is not limited to the embodiment. All of the shapes, the combinations, and the like of the constituent members shown in the embodiment described above are merely examples, and various changes can be made based on design requirements and the like within a range not departing from the scope of the present disclosure.

### INDUSTRIAL APPLICABILITY

According to a cryogenic liquid tank including a support portion supporting a reservoir of the present disclosure, it is possible to prevent a significant load from being applied to a bottom portion of the reservoir while being in use.

### REFERENCE SIGNS LIST

1 cryogenic liquid tank
2 foundation floor slab
3 outer tank
3a outer tank side wall
3b outer tank ceiling portion
4 bottom portion cold reserving layer (support portion)
4b1 end portion
4b outer support portion (outer circumferential portion)
4a inner support portion (central portion)
5 inner tank (reservoir)
5a inner tank bottom portion (bottom portion)
5a1 outer bottom plate (bottom portion)
5a2 inner bottom plates (bottom portion)
5a3 joint portion
5b inner tank side wall (side wall)
5d ceiling
6 side portion cold reserving layer
7 blanket
8 pearlite
9 thermal corner protection
9a annular plate (cover portion)
9b thermal corner wall plate
9c inner end surface
9a′ annular plate
9a1 extending portion (cover portion)
10 lean concrete
11 thermal corner bottom plate
11a outer end surface
15 cover plate (cover portion)
15a inner end surface
20 recess portion
B boundary
D distance

1. A cryogenic liquid tank comprising:
a reservoir that includes a bottom portion and a side wall;
a support portion that supports the reservoir; and
an intermediate member that is provided between the reservoir and the support portion,
wherein the support portion includes an outer support portion which supports the side wall, and an inner support portion which is disposed to be adjacent to an inner side of the outer support portion, includes a heat insulating layer formed of an elastic material, and supports the bottom portion of the reservoir, and
wherein a cover portion covering a boundary between the outer support portion and the inner support portion is provided between the support portion and the intermediate member.

2. The cryogenic liquid tank according to claim 1,
wherein the cover portion is an annular plate provided on the outer support portion and on the inner support portion, and
wherein the annular plate includes an extending portion extending from the outer support portion toward the inner support portion.

3. The cryogenic liquid tank according to claim 1,
wherein an annular plate is disposed on the outer support portion, and
wherein the cover portion is a cover plate which is provided to be adjacent to an inner side of the annular plate and is a member separated from the annular plate.

4. The cryogenic liquid tank according to claim 1,
wherein the cover portion includes a recess portion provided at a position overlapping the boundary between the outer support portion and the inner support portion.

5. The cryogenic liquid tank according to claim 2,
wherein the cover portion includes a recess portion provided at a position overlapping the boundary between the outer support portion and the inner support portion.

6. The cryogenic liquid tank according to claim 3,
wherein the cover portion includes a recess portion provided at a position overlapping the boundary between the outer support portion and the inner support portion.
